(19) United States
(12) Patent Application Publication
(10) Pub. No.: US 2025/0076200 A1
(43) Pub. Date: Mar. 6, 2025

(54) CLEANING METHOD AND APPARATUS FOR WASHING TOOL, SUBSTRATE WASHING APPARATUS AND MANUFACTURING METHOD FOR WASHING TOOL

(71) Applicant: EBARA CORPORATION, Tokyo (JP)

(72) Inventors: MEGUMI UNO, Tokyo (JP); YUMIKO NAKAMURA, Tokyo (JP); CHIKAKO TAKATOH, Tokyo (JP)

(73) Assignee: EBARA CORPORATION, Tokyo (JP)

(21) Appl. No.: 18/808,100

(22) Filed: Aug. 19, 2024

(30) Foreign Application Priority Data
Aug. 31, 2023 (JP) 2023-140916

(51) Int. Cl. G01N 21/64; B08B 1/14; B08B 1/52; B08B 1/54; B08B 3/10

(52) U.S. Cl. CPC G01N 21/6428; B08B 1/14; B08B 1/52; B08B 1/54; B08B 3/10

(57) ABSTRACT

A cleaning apparatus for performs a cleaning process on a washing tool for substrate washing by supplying a washing liquid to the washing tool and bringing the washing tool into contact with a cleaning member. The cleaning apparatus includes: a liquid extraction part that extracts a washing liquid remaining inside the washing tool or a washing liquid flowing out from the washing tool during the cleaning process; a fluorescence analysis part that performs fluorescence analysis on the washing liquid extracted by the liquid extraction part and measures a fluorescence intensity of the washing liquid for an excitation light of a predetermined wavelength; and a judgement part that judges, based on the measured fluorescence intensity, whether or not the cleaning of the washing tool has been completed.

### CROSS-REFERENCE TO RELATED APPLICATION

This application claims the priority benefits of Japanese application no. 2023-140916, filed on Aug. 31, 2023. The entity of the above-mentioned patent application is hereby incorporated by reference herein and made a part of this specification.

### BACKGROUND

### Technical Field

The disclosure relates to a cleaning method and apparatus for a washing tool for substrate washing after polishing, a substrate washing apparatus, and a manufacturing method for the washing tool.

### Related Art

One method for planarizing the surface of a substrate for forming semiconductor devices is polishing with a chemical mechanical polishing (CMP) apparatus. In CMP, the surface of an object to be polished, such as a substrate, is pressed against a polishing member, and a polishing liquid is supplied between the polishing member and the object to be polished while the polishing member and the object to be polished are moved relative to each other, thereby polishing the surface of the object to be polished flat.

In general, a polishing apparatus for polishing a substrate includes a substrate washing apparatus for washing the polished substrate. The substrate washing is performed by bringing a washing tool such as a roll sponge or a pen sponge into contact with the polished substrate while rotating the substrate.

The washing tool used in substrate washing is, for example, a sponge made of PVA (polyvinyl alcohol), and is used by being set in a washing apparatus. Here, the degree of cleanliness used in washing semiconductor devices is much higher than the degree of cleanliness required in the manufacturing process of the washing tool, so the washing tool needs to be cleaned prior to use in substrate washing. Specifically, washing and rinsing process is performed using a combination of ultrapure water, alkaline chemicals, or enzyme-based washing liquid. The washing tool is cleaned when it is replaced with a new one (called break-in) or after each washing of a predetermined number of substrates.

Furthermore, the substrate washing apparatus described in Patent Document 1 discloses a technology for extracting the washing liquid remaining inside the washing tool (or flowing out from the washing tool) during the cleaning process, subjecting the extracted washing liquid to an iodine color reaction, detecting its color degree, and judging based on the detected color degree whether or not the cleaning of the washing tool has been completed.

### CITATION LIST

### Patent Document

[Patent Document 1] Japanese Patent Laid-open No. JP2022-34694

According to the technique described in the above-mentioned Patent Document 1, an iodine solution is required since the washing degree is judged by utilizing an iodine color reaction. Furthermore, in order to grasp the content of starch or cross-linked PVA, a starch-decomposing enzyme is required, which not only complicates the judgement process but also requires disposal of waste liquid such as iodine solution and decomposing enzyme. For this reason, there has been a demand for a method that can confirm the washing degree in a simpler manner and places little burden on the environment.

The disclosure has been made in consideration of the above, and aims to provide a cleaning method and apparatus, a substrate washing apparatus, and a manufacturing method for a washing tool, that enables confirmation of the washing degree of a washing tool in a simple manner and places little burden on the environment.

### Solution to Problem

The inventors of the application have conducted extensive research into the types of defects transferred from a PVA brush, which is a washing tool, to a substrate, which is an object to be washed, and a method for detecting the same. FIG. 1 shows an example of the results of fluorescence spectroscopic analysis, using a spectrofluorometer, of a liquid (brush extract) discharged when a PVA brush used as a washing tool is washed with pure water. The graph in FIG. 1 shows an example of a fluorescence spectrum when the wavelength of the excitation light is 225 nm.

It may be seen from the fluorescence spectrum in FIG. 1 that peaks are observed at fluorescence wavelengths of about 290 nm and about 340 nm. Where the eluate (extract) from the PVA brush mainly contains starch and PVA, the fluorescence wavelength derived from the reference (soluble starch reagent) is around 280 nm, indicating that the peak around 340 nm in FIG. 1 is a peak derived from PVA.

FIG. 1 shows the change in the fluorescence spectrum when the immersion time (washing time) of the PVA brush is increased from 0.5 hours (0.5 h) to 2 hours (2.0 h). The multiple graphs in FIG. 1 show that as the immersion time increases, the peaks near 290 nm and near 340 nm become lower, indicating that defects (starch and PVA eluates) are reduced as the PVA brush is immersed (washed), and that after about 1.5 hours of washing process, the defects are reduced to a constant value or below a threshold value.

FIG. 2 is a graph illustrating an example of changes in fluorescence intensity versus immersion time, illustrating the change in fluorescence intensity versus time for excitation light wavelength/fluorescence wavelength: 220 nm/295 nm (derived from starch) and excitation light wavelength/fluorescence wavelength: 225 nm/340 nm (derived from PVA). According to the graph in FIG. 2, as the immersion time increases, the fluorescence intensity (vertical axis of the graph) decreases, indicating that defects (starch eluates, PVA eluates) are reduced as the PVA brush is immersed (washed), and that after about 1.5 hours of washing process, the defects reach a certain value or below.

In the above-mentioned fluorescence spectroscopic analysis, similar results were obtained not only in the case of immersion in pure water, but also in the case of immersion process in ammonia water. In this way, it was found that by subjecting the eluate from the PVA brush to fluorescence spectroscopic analysis and monitoring the peak intensity at a specific wavelength, it is possible to detect and determine the degree to which the brush has been washed, i.e., whether it has been cleaned to a level that makes it usable for substrate washing.

### SUMMARY

One aspect of the disclosure is a cleaning apparatus for performing a cleaning process on a washing tool for substrate washing by supplying a washing liquid to the washing tool and bringing the washing tool into contact with a cleaning member. The cleaning apparatus is configured to include a liquid extraction part that extracts a washing liquid remaining inside the washing tool or a washing liquid flowing out of the washing tool during the cleaning process; a fluorescence analysis part that performs fluorescence analysis on the washing liquid extracted by the liquid extraction part and measures a fluorescence intensity of the washing liquid for an excitation light of a predetermined wavelength; and a judgement part that judges, based on the measured fluorescence intensity, whether or not the cleaning of the washing tool has been completed.

Another aspect of the disclosure is a cleaning method for cleaning a washing tool for substrate washing. The cleaning method includes: a washing step of cleaning the washing tool by supplying a washing liquid to the washing tool and bringing the washing tool into contact with a cleaning member; an extraction step of extracting a washing liquid remaining inside the washing tool or a washing liquid flowing out from the washing tool in the washing step; a fluorescence analysis step of performing a fluorescence analysis on the washing liquid extracted in the extraction step and measuring an intensity of the fluorescence of the washing liquid for an excitation light of a predetermined wavelength; and a judgement step of judging, based on the measured fluorescence intensity, whether or not the cleaning of the washing tool has been completed.

### BRIEF DESCRIPTION OF THE DRAWINGS

FIG. 1 is a graph illustrating an example of a fluorescence spectrum when the immersion time (washing time) of a PVA brush is changed.

FIG. 2 is a graph illustrating an example of changes in fluorescence intensity versus immersion time.

FIG. 3 is a plan diagram illustrating a schematic configuration of a substrate processing apparatus including a substrate washing apparatus according to an embodiment of the disclosure.

FIG. 4 is a perspective diagram illustrating a configuration of a substrate washing apparatus according to an embodiment of the disclosure.

FIG. 5 is a perspective diagram illustrating a configuration of a substrate washing apparatus according to another embodiment of the disclosure.

FIG. 6 is a diagram schematically illustrating self-cleaning of a pen member.

FIG. 7 is a diagram schematically illustrating self-cleaning of a roll member.

FIG. 8 is an explanatory diagram illustrating the functional configuration of a washing evaluation apparatus.

FIG. 9 is an explanatory diagram schematically illustrating a photometric method for fluorescence spectroscopic analysis.

FIG. 10 is a flow chart illustrating a procedure for a washing evaluation process.

### DESCRIPTION OF THE EMBODIMENTS

According to the disclosure, the washing degree of a washing tool can be confirmed using a simple method that places little burden on the environment.

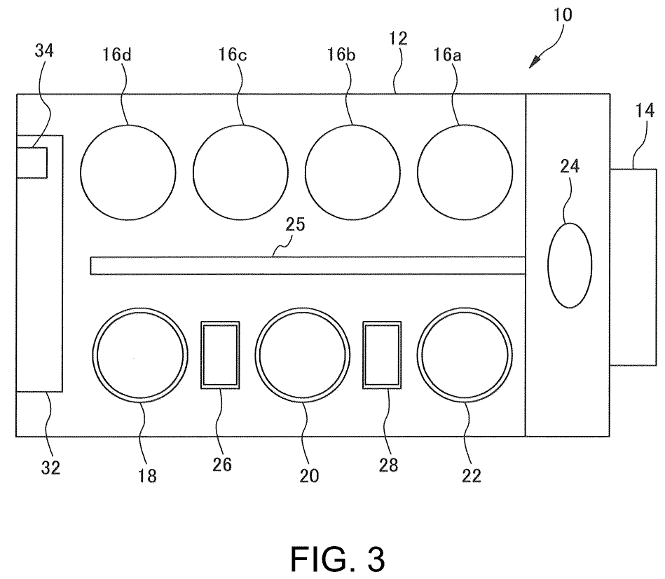

Hereinafter, an embodiment of the disclosure will be described with reference to the drawings. FIG. 3 shows an outline of a substrate processing apparatus including a substrate washing apparatus according to an embodiment, and a substrate processing apparatus 10 includes a housing 12 and a load port 14. An open cassette that accommodates a plurality of substrates W, for example, is mounted on the load port 14.

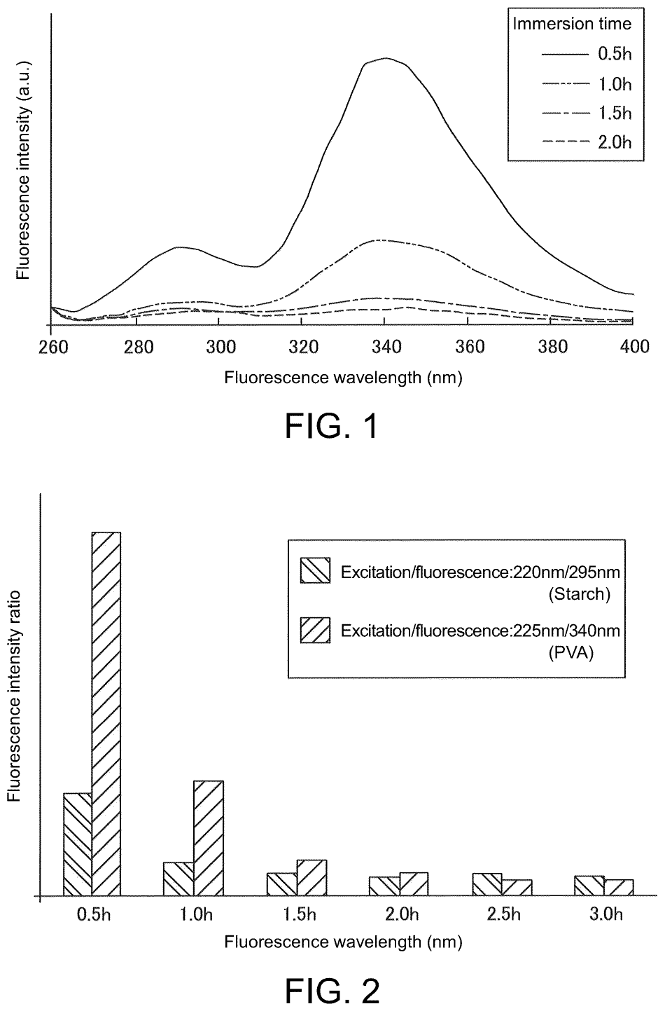

The housing 12 accommodates a plurality of polishing units 16a to 16d for polishing (planarizing) the substrate W, a first washing unit 18 and a second washing unit 20 for washing the substrate W after polishing, and a drying unit 22 for drying the substrate W after washing. In the example of FIG. 1, the polishing units 16a to 16d are arranged along the longitudinal direction of the substrate processing apparatus 10, and the washing units 18 and 20 and the drying unit 22 are arranged in parallel to the polishing units 16a to 16d.

A first transport robot 24 is disposed between the load port 14 and the polishing unit 16a and the drying unit 22 located on the load port 14 side. The unpolished substrate W is received from the load port 14 and transferred to a transport unit 24, and the dried substrate W removed from the drying unit 22 is received from the transport unit 24. Moreover, the transport unit 25 is disposed between the polishing units 16a to 16d and the washing units 18 and 20 and the drying unit 22.

A second transport robot 26 is disposed between the first washing unit 18 and the second washing unit 20 for transferring the substrate W therebetween. Moreover, a third transport unit 28 is disposed between the second washing unit 20 and the drying unit 22 for transferring the substrate W therebetween.

A control part 32 that controls the operation of each device in the substrate processing apparatus 10 is disposed inside the housing 12. In the embodiment, the control part 32 is disposed inside the housing 12, but the control part 32 may also be disposed outside the housing 12 and configured to be connected to the substrate processing apparatus 10 via a network. The control part 32 also includes an input part 34 that receives external input. Here, the external input includes mechanical operations by the user as well as input of signals from external apparatuses via wired or wireless connections.

The washing units 18 and 20 of the embodiment wash the substrate W by making a washing tool, which will be described later, rotate on its own relative to the substrate W and bringing it into contact with the surface of the substrate W. Moreover, the washing units 18 and 20 may use, in combination with the washing tool, a two-fluid jet washing apparatus that washes the surface of the substrate W with a two-fluid jet. As an example, the drying unit 22 dries the substrate W by ejecting IPA vapor from a nozzle (not shown) toward the rotating substrate W. Alternatively, the substrate W may be rotated at high speed and dried by centrifugal force.

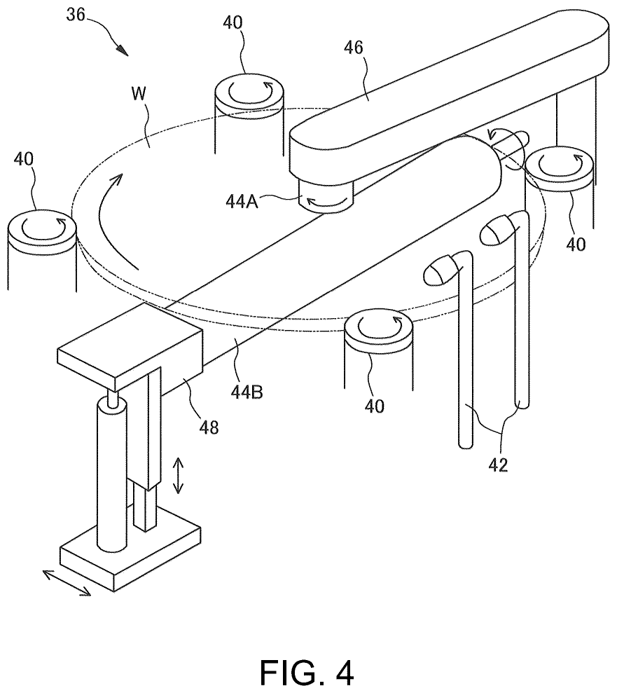

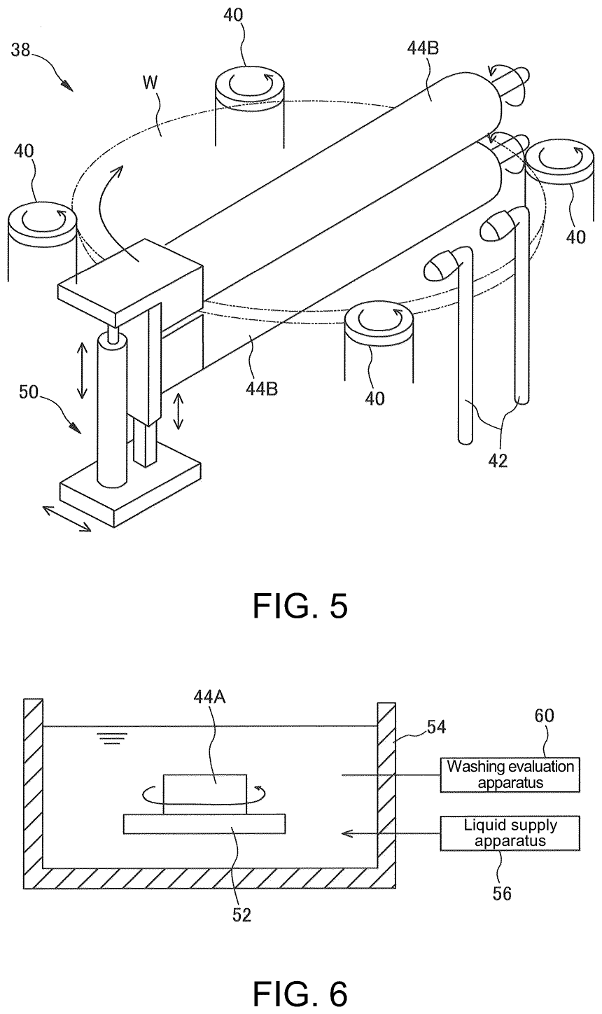

FIG. 4 is a perspective diagram illustrating a schematic configuration of a substrate washing apparatus 36 according to an embodiment, and FIG. 5 is a perspective diagram illustrating a schematic configuration of a substrate washing apparatus 38 according to another embodiment. The substrate washing apparatuses 36, 38 (corresponding to the substrate washing units 18, 20 in FIG. 3) each include a substrate rotation mechanism that holds and rotates the substrate W, and a washing liquid supply part 42 that supplies a washing liquid to the substrate W. As the washing liquid, for example, depending on the type of film on the surface of target substrate, a rinsing liquid such as ultrapure water (DIW), other chemical solutions such as alkaline solution (ammonia water, ammonia hydrogen peroxide (SC1)), a surfactant, a chelating agent, or a mixed chemical solution thereof may be used.

The substrate W rotates with its central axis as the rotation axis. In the embodiment, a case will be described in which the surface of the substrate W extends along the horizontal direction and the rotation axis extends in the vertical direction, but the disclosure is not limited thereto. The substrate rotation mechanism of the embodiment includes four support members 40 that support the outer periphery of the substrate W. The support member 40 is, for example, a spindle or a chuck, and rotates the substrate W by rotation.

The substrate washing apparatuses 36, 38 include washing tools for washing the substrate W that they come into contact with. In the example of FIG. 4, a pen member 44A that rotates on its own around a rotation axis substantially perpendicular to the surface of the substrate W and a roll member 44B that extends linearly over almost the entire diameter of the substrate W are used as the washing tool. In the example of FIG. 5, a pair of roll members 44B extending linearly over almost the entire diameter of the substrate W is used as the washing tool.

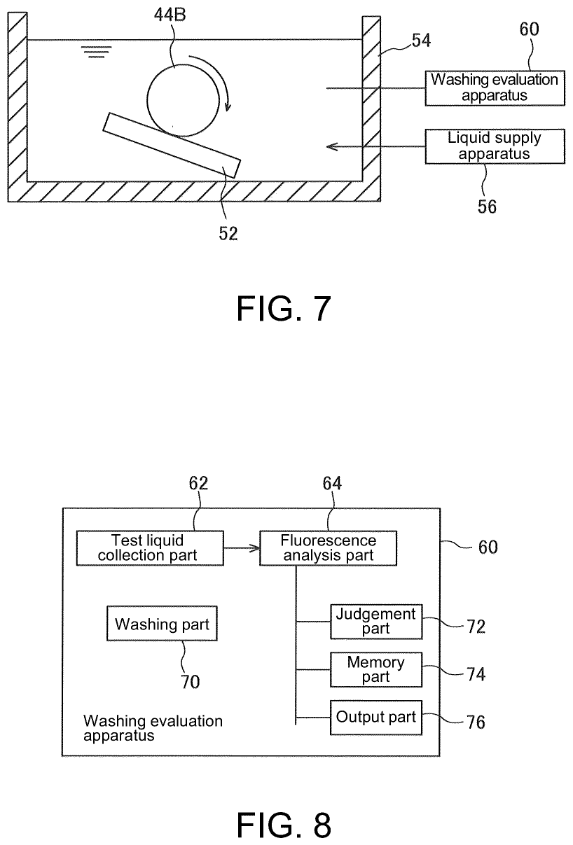

The substrate washing apparatus 36 of FIG. 4 includes washing tool rotation mechanisms 46, 48 that hold and rotate the washing tools, the pen member 44A and the roll member 44B, respectively, and rotate the pen member 44A around a rotation axis substantially perpendicular to the surface of the substrate W. Moreover, the substrate washing apparatus 38 shown in FIG. 7 includes a washing tool rotation mechanism 50 that holds the roll member 44B, which is a washing tool, and rotates it around a rotation axis parallel to the surface of the substrate W. The washing tool rotation mechanisms 46, 48, 50 move the washing tools 44A, 44B parallel to the surface of the substrate W to a contact position where they come into contact with the substrate W and a standby position (not shown).

In the example shown in FIG. 4, the pen member 44A washes the upper surface of the substrate W, and the roll member 44B washes the lower surface of the substrate W. In the example shown in FIG. 5, the pair of roll members 44B washes the front surface and back surface of the substrate W. It should be noted that the configuration of the substrate washing apparatus is not limited to these examples as long as the substrate W is washed by the washing tool coming into contact with the surface of the substrate W.

New washing tools 44A and 44B have particles adhering to their surfaces and insides that may cause contamination, and therefore cannot be used as is to wash semiconductor devices. When a washing process is performed on the substrate W using such a washing tool, the clean substrate W may be contaminated by the washing tool. For this reason, before a new washing tool is used for substrate processing, a predetermined washing process (break-in) is performed.

FIG. 6 is a diagram schematically illustrating a configuration of an apparatus for break-in the pen member 44A, and FIG. 7 is a diagram schematically illustrating a configuration of an apparatus for break-in the roll member 44B. As shown in FIGS. 6 and 7, a cleaning member 52 is disposed in a liquid tank 54. The cleaning member 52 is formed of an inorganic oxide material such as a quartz plate or a sapphire plate, or an organic polymer material having good chemical resistance and low elution properties such as PTFE, PVDF, PFA, PPS, PEEK, or PMMA. Moreover, the liquid tank 54 stores liquids (washing liquids) such as rinsing liquids such as ultrapure water (pure water) (DIW), or chemical solutions such as alkaline solutions (ammonia water, ammonia hydrogen peroxide (SC1)), substrate washing liquids, and starch-decomposing enzyme solutions.

A liquid supply apparatus 56 is connected to the liquid tank 54, and thereby chemical solution is supplied during chemical washing and pure water is supplied during rinsing process to the liquid tank 54 as a washing liquid. The washing liquid may be configured to be circulated through the liquid tank 54 while being cleaned. Moreover, it is preferable that the temperature of the liquid stored in the liquid tank 54 may be adjusted by a temperature adjustment mechanism such as a heater. Furthermore, a vibration part may be provided in the liquid tank 54 for applying ultrasonic vibrations to the liquid tank 54 when cleaning the washing tools 44A and 44B.

As shown in FIG. 6, when cleaning the pen member 44A, the washing tool rotation mechanism 46 rotates the pen member 44A while pressing the pen member 44A against the cleaning member 52. Although FIG. 6 shows an example in which the surface of the cleaning member 52 is perpendicular to the rotation axis of the pen member 44A, the disclosure is not limited to this example.

As shown in FIG. 7, when cleaning the roll member 44B, the washing tool rotation mechanisms 48 and 50 rotate the roll member 44B while pressing the roll member 44B against the cleaning member 52. In the example shown in FIG. 7, although the surface of the cleaning member 52 is inclined with respect to the vertical direction and the roll member 44B moves in the vertical direction to come into contact with the cleaning member, the disclosure is not limited to this example.

The liquid discharged from the liquid tank 54 is discharged to the outside of the apparatus, or sent to the liquid supply apparatus 56 by a circulation mechanism (not shown) for reuse. Moreover, the washing liquid and pure water for rinsing may be supplied to the liquid tank 54 from the liquid supply apparatus 56 as shown in FIGS. 6 and 7, but a method of pressurized supply from the liquid supply apparatus 56 to the outside of the brushes via liquid supply ports provided inside the brushes 44A to 44B may also be adopted. In the case of the method of pressurized supply, it is possible to effectively push out foreign matter present deep inside the brush. Moreover, the depth of the liquid tank 54 may be made shallow such that most of the brush is exposed, and the washing liquid and pure water for rinsing may be sprayed directly onto the brush by a spray or the like.

The liquid tank 54 is connected to a washing evaluation apparatus 60 for evaluating the washing degree of the washing tools 44A, 44B. FIG. 8 is a block diagram illustrating an example of the configuration of the washing evaluation apparatus 60. The washing evaluation apparatus 60 includes a test liquid collection part (liquid extraction part) 62, a fluorescence analysis part 64, a washing part 70, a judgement part 72, a memory part 74, and an output part 76. The washing evaluation apparatus 60 and the liquid tank 54 are provided inside or in the vicinity of the substrate washing apparatus 36, and during the break-in process, the washing tools 44A, 44B are subjected to washing with a chemical solution and rinsing process with pure water.

The test liquid collection part 62 includes a test liquid collection port and a reduced pressure generating mechanism (e.g., a pump), and the test liquid collection port is pressed against the surfaces of the washing tools 44A, 44B after they are subjected to washing and rinsing process, and the reduced pressure generating mechanism reduces the pressure inside the test liquid collection port to suck and collect the liquid remaining inside the pores on the surface of the washing tools 44A, 44B, which are PVA sponges (liquid that may contain eluates from the washing tools 44A, 44B; hereinafter referred to as the “remaining liquid”).

The collection of remaining liquid by the test liquid collection part 62 is not limited to the above-mentioned manner, and the remaining liquid may be collected, for example, by collecting the liquid that drops when the washing tools 44A, 44B are brought into contact with and rotated against the cleaning member 52, by collecting waste liquid after the washing process of the substrate W (test substrate) using the washing tools 44A, 44B, or by collecting inner rinse liquid that has passed through the inside of the washing tools 44A, 44B.

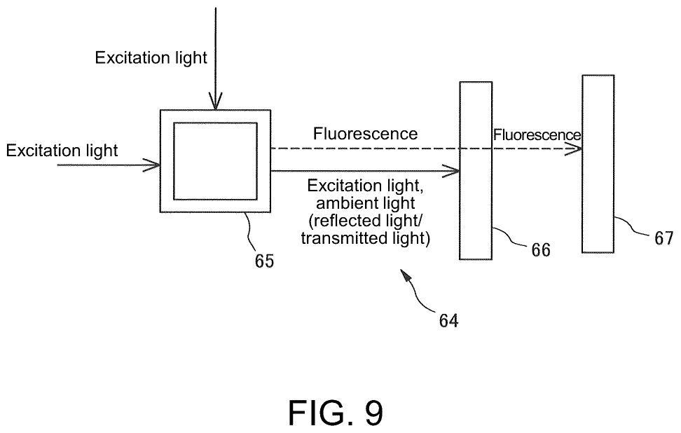

The fluorescence analysis part 64 performs fluorescence analysis on the remaining liquid collected by the test liquid collection part 62 using a fluorometer. FIG. 9 is a diagram illustrating a schematic configuration of the fluorescence analysis part 64, in which excitation light is irradiated from a light irradiation part (not shown) onto a sample 65 containing remaining liquid. Of the excitation light and the fluorescence emitted from the sample 65 by the excitation light, only the fluorescence passes through a fluorescence filter 66 disposed on the optical path, and only the fluorescence from the sample 65 is detected by a detector 67. Then, the fluorescence analysis part 64 extracts the fluorescence corresponding to the excitation light of a predetermined wavelength.

The wavelength (predetermined wavelength) of the excitation light for extracting fluorescence in the fluorescence analysis part 64 is preferably in the wavelength range of 200 nm to 290 nm, and particularly preferably 220 nm to 225 nm, from the viewpoint of simultaneously detecting the spectra derived from starch and derived from PVA. Furthermore, the wavelength of the excitation light corresponding to starch measurement and the wavelength of the excitation light corresponding to PVA measurement may be the same wavelength, or may be different wavelengths (for example, the wavelength of the excitation light corresponding to starch is 220 nm, and the wavelength of the excitation light corresponding to PVA is 225 nm).

The judgement part 72 judges whether the fluorescence intensity at a predetermined wavelength of the fluorescence measured by the fluorescence analysis part 64 falls below a predetermined threshold value, and if so, sends an indication to the output part 76 that washing of the washing tools 44A, 44B should be terminated. On the other hand, if the measured absorbance value is equal to or greater than the threshold value, an instruction to continue washing the washing tools 44A and 44B is sent to the substrate washing apparatus 36. This makes it possible to evaluate the degree of remaining contaminants that may cause defects in the starch and PVA remaining inside the washing tool without performing inspection using a defect inspection apparatus.

Here, the predetermined wavelengths of fluorescence to be judged by the judgement part 72 are the fluorescence wavelength derived from starch (for example, 295 nm) and the fluorescence wavelength derived from PVA (for example, 340 nm). The judgement part 72 judges whether or not the corresponding fluorescence intensity for both the fluorescence wavelengths derived from starch and PVA falls below a predetermined threshold value. Alternatively, since both starch and PVA are removed by washing the washing tools 44A, 44B, it may be configured to judge whether the corresponding fluorescence intensity for one of the fluorescence wavelengths derived from starch and PVA has fallen below a predetermined threshold value.

The memory part 74 stores information about threshold values (of the fluorescence intensity) used in the judgement process in the judgement part 72. Moreover, the memory part 74 may also be configured to store information on the results of performing fluorescence spectroscopic analysis on pure water (not used for rinsing process of the washing tools 44A, 44B), and subtract the measured values for the pure water and washing liquid from the measured values for the fluorescence intensity for the remaining liquid from the washing tools 44A, 44B.

The washing part 70 performs washing process on the test liquid collection part 62 with pure water every time the washing evaluation apparatus 60 measures the fluorescence intensity of the remaining liquid. This prevents the influence (contamination) of the remaining liquid used in a previous fluorescence intensity measurement from occurring when measuring the fluorescence intensity of the remaining liquid.

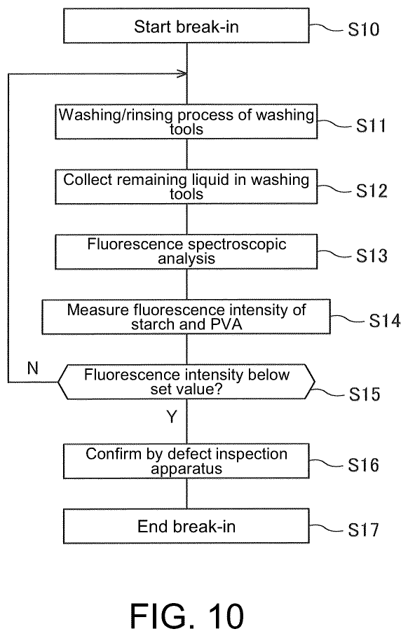

The procedure for break-in the washing tool having the above-described configuration will be described below with reference to the flow chart of FIG. 10. When the washing tools 44A, 44B are replaced and break-in is started (step S10), the washing tools 44A, 44B are set in the liquid tank 54 filled with the chemical solution. The washing tools 44A and 44B rotate while being pressed against the cleaning member 52, whereby the washing tools 44A and 44B are washed, and are then subjected to rinsing process with pure water (step S11).

When the rinsing process is completed, the test liquid collection part 62 collects the remaining liquid in the washing tools 44A and 44B (step S12). When a certain amount of remaining liquid has been collected, the sample containing the remaining liquid is irradiated with excitation light in the fluorescence analysis part 64 for fluorescence analysis, and the fluorescence intensity for the excitation light of a predetermined wavelength is detected (step S13). Then, the fluorescence analysis part 64 measures the fluorescence intensity at specific wavelengths (for example, 295 nm and 340 nm) derived from starch and PVA (step S14). The fluorescence intensity data obtained by the measurement is stored in the memory part 74 of the washing evaluation apparatus 60.

When the measurement of the fluorescence intensity is completed, the judgement part 72 judges whether the measured value falls below a set value (threshold value) (step S15), and if so, judges that the starch and cross-linked PVA concentrations are sufficiently low (i.e., starch and cross-linked PVA have been sufficiently removed from the washing tools 44A, 44B after the washing and rinsing process), and displays an output indicating that the evaluation by fluorescence analysis is terminated. Then, the test substrate subjected to washing process by the washing tools 44A and 44B is set in a defect inspection apparatus and checked for the presence or absence of defects (step S16). This ends the break-in process (step S17). The check by the defect inspection apparatus may be omitted. Furthermore, as the set value of the fluorescence intensity, data of the measured fluorescence intensity regarding a brush that has been previously determined to have completed break-in may be used.

On the other hand, if the measured value of the fluorescence intensity is equal to or greater than the set value (“N” in step S15), the process returns to step S11, the brush washing and rinsing process is again performed on the washing tools 44A and 44B, and fluorescence analysis and measurement of the fluorescence intensity are performed. This makes it possible to reduce the frequency of confirming for the presence or absence of defects using a defect inspection apparatus, thereby making it possible to shorten the break-in process and improve its efficiency.

Moreover, after rinsing process of the washing tools 44A, 44B with pure water, the supply of pure water may be stopped and the washing tools 44A, 44B may be rotated while maintaining pressure on the cleaning members for a predetermined period of time (e.g., one minute), and then the liquid in the brushes may be collected. This allows the washing tools 44A and 44B to be rinsed with the same rinsing water, increasing the concentration of the eluted matter from the washing tools 44A and 44B, thereby improving the analytical sensitivity of the fluorescence intensity measurement based on the fluorescence analysis.

Furthermore, when washing the washing tools 44A and 44B, the washing liquid may be foamed and supplied to the washing tools 44A and 44B instead of flowing the washing liquid as it is. Specifically, the washing liquid is foamed by supplying clean air (so as to be equal to or greater than the solubility of the washing liquid) through a gas-dissolving membrane, or by adding a surfactant and foaming with mechanical stirring. During break-in, only the washing liquid that comes into contact with the surfaces of the washing tools 44A, 44B contributes to washing, so in a mode in which the washing liquid is allowed to flow in, most of the washing liquid does not contribute to washing and is discarded. By using a foamed washing liquid, the amount of washing liquid can be significantly reduced, thereby lowering the cost required for break-in.

In the above embodiment, an example has been described in which a break-in process is performed after the washing tool is set in the substrate washing apparatus, but the disclosure is not limited thereto and may be equally applied to, for example, a situation in which a washing tool is inspected for defects before shipment.

In the above embodiment, although the above description is given taking as an example a case where a cleaning process is performed on a washing tool that performs substrate washing in chemical mechanical polishing (CMP), the disclosure is not limited to CMP and may be equally applied to a mode in which a substrate is scrub-washed using a PVA brush.

In the above embodiment, the procedure for break-in the washing tool with reference to the flow chart of FIG. 10 may be performed by a washing evaluation apparatus provided inside or in the vicinity of the substrate washing apparatus, or disposed remotely from the substrate washing apparatus (e.g. disposed in a cloud). The washing evaluation apparatus is, for example, a computer including one or more hardware processors and a recording medium storing a program. The hardware processor is, for example, a central processing unit (CPU), and is configured to load the program from the recording medium so as to execute the program, thereby performing the procedure for break-in the washing tool. The recording medium is, for example, a “non-transitory computer readable recording medium” such as a read only memory (ROM), a hard drive, a disk, a memory card, a programmable logic circuit, or the like, which is not limited herein.

The above-described embodiments have been described for the purpose of enabling a person having ordinary skill in the art to which the disclosure pertains to practice the disclosure. Various modifications of the above-described embodiment would naturally be possible for a person skilled in the art, and the technical concept of the disclosure may also be applied to other embodiments. The disclosure is not limited to the described embodiments, but is to be interpreted in the broadest scope according to the technical ideas defined by the claims.

What is claimed is:

1. A cleaning apparatus for performing cleaning process on a washing tool for substrate washing by supplying a washing liquid to the washing tool and bringing the washing tool into contact with a cleaning member while, the cleaning apparatus comprising:
a liquid extraction part that extracts a washing liquid remaining inside the washing tool or a washing liquid flowing out from the washing tool during the cleaning process;
a fluorescence analysis part that performs fluorescence analysis on the washing liquid extracted by the liquid extraction part and measures a fluorescence intensity of the washing liquid for an excitation light of a predetermined wavelength; and
a judgement part that judges, based on the measured fluorescence intensity, whether or not the cleaning of the washing tool has been completed.

2. The cleaning apparatus according to claim 1, wherein the fluorescence analysis part measures, among fluorescence of the washing liquid for the excitation light of the predetermined wavelength, a fluorescence intensity of a first wavelength, and judges that the cleaning of the washing tool is completed when a measured value of the fluorescence intensity is less than a set value.

3. The cleaning apparatus according to claim 1, wherein the fluorescence analysis part measures, among fluorescence of the washing liquid for the excitation light of the predetermined wavelength, a fluorescence intensity of a first wavelength and a fluorescence intensity of a second wavelength, and judges that the cleaning of the washing tool is completed when the fluorescence intensity of the first wavelength is less than a first set value and the fluorescence intensity of the second wavelength is less than a second set value.

4. The cleaning apparatus according to claim 3,
wherein the washing tool is a PVA sponge; and
the first wavelength corresponds to a fluorescence wavelength of starch and the second wavelength corresponds to a fluorescence wavelength of PVA.

5. A cleaning method for cleaning a washing tool for substrate washing, the cleaning method comprising:
a washing step of cleaning the washing tool by supplying a washing liquid to the washing tool and bringing the washing tool into contact with a cleaning member;
an extraction step of extracting a washing liquid remaining inside the washing tool or a washing liquid flowing out from the washing tool in the washing step;
a fluorescence analysis step of performing a fluorescence analysis on the washing liquid extracted in the extraction step and measuring an intensity of a fluorescence spectrum of the washing liquid for an excitation light of a predetermined wavelength; and
a judgement step of judging, based on the measured fluorescence intensity, whether or not the cleaning of the washing tool has been completed.

6. The cleaning method according to claim 5, wherein the washing liquid is pure water, an alkaline solution, a substrate washing liquid, or a starch-decomposing reagent.

7. A manufacturing method for a washing tool for substrate washing, wherein the washing tool is manufactured by performing the cleaning method according to claim 5 on the washing tool.

8. A manufacturing method for a washing tool for substrate washing, wherein the washing tool is manufactured by performing the cleaning method according to claim 6 on the washing tool.

9. A substrate washing apparatus, comprising the cleaning apparatus according to claim 1, wherein a washing process is performed on a substrate using the washing tool that was subjected to a washing process by the cleaning apparatus.

10. A substrate washing apparatus, comprising the cleaning apparatus according to claim 2, wherein a washing process is performed on a substrate using the washing tool that was subjected to a washing process by the cleaning apparatus.

11. A substrate washing apparatus, comprising the cleaning apparatus according to claim 3, wherein a washing process is performed on a substrate using the washing tool that was subjected to a washing process by the cleaning apparatus.

12. A substrate washing apparatus, comprising the cleaning apparatus according to claim 4, wherein a washing process is performed on a substrate using the washing tool that was subjected to a washing process by the cleaning apparatus.

13. A non-transitory computer readable recording medium storing a program causing a computer to execute the cleaning method according to claim 5.

14. A non-transitory computer readable recording medium storing a program causing a computer to execute the cleaning method according to claim 6.
